(19) United States
(12) Patent Application Publication
(10) Pub. No.: US 2017/0005795 A1
(43) Pub. Date: Jan. 5, 2017

(54) Key Generation Method, Master eNodeB, Secondary eNodeB and User Equipment

(71) Applicant: Huawei Technologies Co., Ltd., Shenzhen (CN)

(72) Inventors: Lu Gan, Shenzhen (CN); Rong Wu, Shenzhen (CN); Chengdong He, Dongguan (CN)

(21) Appl. No.: 15/268,808

(22) Filed: Sep. 19, 2016

Related U.S. Application Data
(63) Continuation of application No. PCT/CN2015/074324, filed on Mar. 16, 2015.

(30) Foreign Application Priority Data
Mar. 18, 2014 (CN) 201410100651.8

(51) Int. Cl. H04L 9/08; H04L 29/06; H04W 76/02

(52) U.S. Cl. CPC H04L 9/0869; H04W 76/021; H04L 63/061; H04L 63/123

(57) ABSTRACT

The present disclosure relates to a key generation method, a master eNodeB, a secondary eNodeB, and UE. The key generation method includes: determining a key parameter corresponding to a data radio bearer DRB; sending the key parameter to UE corresponding to the DRB, so that the UE generates a user plane key according to the key parameter and a basic key generated by the UE; receiving a basic key generated by a master eNodeB and sent by the master eNodeB; and generating the user plane key according to the key parameter and the basic key generated by the master eNodeB.

### CROSS-REFERENCE TO RELATED APPLICATIONS

This application is a continuation application of international application number PCT/CN2015/074324 filed on Mar. 16, 2015, which claims priority to Chinese patent application number 201410100651.8 filed on Mar. 18, 2014, both of which are incorporated by reference.

### TECHNICAL FIELD

The present disclosure relates to the field of communications technologies, and in particular, to a key generation method, a master evolved node B (eNodeB), a secondary eNodeB, and a user equipment (UE).

### BACKGROUND

With development of communications technologies, a fourth generation (4G) communications system is widely used. In the 4G communications system, to improve a user plane data throughput of UE, the UE may connect to both a master eNodeB (MeNB) and a secondary eNodeB (SeNB), and the UE may simultaneously transmit user plane data to the master eNodeB and the secondary eNodeB. The master eNodeB is a macro base station, or macro eNB or macro cell, and the secondary eNodeB is a small base station, or small eNB or small cell. The small cell is a micro base station such as a pico eNB or pico cell or is a femto base station such as a femto eNB or femto cell.

Considering security of user plane data transmission between the UE and the secondary eNodeB, security protection needs to be performed on user plane transmission between the UE and the secondary eNodeB. In an existing key generation method, user plane keys of the UE and the secondary eNodeB are both generated by the master eNodeB and sent to the UE and the secondary eNodeB, which causes extremely heavy load on the master eNodeB. In addition, for same UE and a secondary eNodeB, only one user plane key is generated, that is, all user plane keys between the secondary eNodeB and the same UE are the same. If one user plane key between the UE and the secondary eNodeB is cracked, all the user plane keys between the same UE and the secondary eNodeB are cracked.

It may be learned that the existing key generation method causes extremely heavy load on a master eNodeB, and security of a generated user plane key between UE and a secondary eNodeB is relatively low.

### SUMMARY

In view of this, embodiments of the present disclosure provide a key generation method, a master eNodeB, a secondary eNodeB, and UE, so as to reduce load of the master eNodeB and improve security of a user plane key between the UE and the secondary eNodeB.

According to a first aspect, an embodiment of the present disclosure provides a key generation method, where the method includes: determining a key parameter corresponding to a data radio bearer (DRB); sending the key parameter to UE corresponding to the DRB, so that the UE generates a user plane key according to the key parameter and a basic key generated by the UE; receiving a basic key generated by a master eNodeB and sent by the master eNodeB; and generating the user plane key according to the key parameter and the basic key generated by the master eNodeB.

In a first possible implementation manner of the first aspect, the determining a key parameter corresponding to a DRB is specifically: allocating or generating a key parameter for the DRB, where the key parameter includes at least one of the following parameters: a DRB identifier (ID), a random number, or a counter value.

In a second possible implementation manner of the first aspect, before the determining a key parameter corresponding to a DRB, the method further includes: receiving a DRB establishing or adding request sent by the master eNodeB, where the DRB establishing or adding request carries the key parameter; and the determining a key parameter corresponding to a DRB is specifically: obtaining the key parameter from the DRB establishing or adding request, where the key parameter includes a DRB ID.

With reference to the first aspect or the first possible implementation manner of the first aspect or the second possible implementation manner of the first aspect, in a third possible implementation manner, the sending the key parameter to UE corresponding to the DRB is specifically: sending the key parameter to the UE by using the master eNodeB.

With reference to the first aspect or the first possible implementation manner of the first aspect or the second possible implementation manner of the first aspect or the third possible implementation manner of the first aspect, in a fourth possible implementation manner, the user plane key is a user plane cipher key or a user plane integrity protection key.

According to a second aspect, an embodiment of the present disclosure provides a key generation method, where the method includes: determining a key parameter corresponding to a DRB; sending the key parameter to UE corresponding to the DRB, so that the UE generates a user plane key according to the key parameter and a basic key generated by the UE; and sending the key parameter and a basic key generated by the master eNodeB to the secondary eNodeB, so that the secondary eNodeB generates the user plane key according to the key parameter and the basic key generated by the master eNodeB; or generating the user plane key according to the key parameter and a basic key generated by a master eNodeB, and sending the user plane key to a secondary eNodeB.

In a first possible implementation manner of the second aspect, the key parameter includes a DRB ID.

With reference to the second aspect or the first possible implementation manner of the second aspect, in a second possible implementation manner, the user plane key is a user plane cipher key or a user plane integrity protection key.

According to a third aspect, an embodiment of the present disclosure provides a secondary eNodeB, where the secondary eNodeB includes: a determining unit configured to determine a key parameter corresponding to a DRB; a sending unit configured to send the key parameter to UE corresponding to the DRB, so that the UE generates a user plane key according to the key parameter and a basic key generated by the UE; a receiving unit configured to receive a basic key generated by a master eNodeB and sent by the master eNodeB; and a generating unit configured to generate the user plane key according to the key parameter and the basic key generated by the master eNodeB.

In a first possible implementation manner of the third aspect, the determining unit is specifically configured to allocate or generate a key parameter to the DRB, where the key parameter includes at least one of the following parameters: a DRB ID, a random number, or a counter value.

In a second possible implementation manner of the third aspect, the receiving unit is further configured to receive a DRB establishing or adding request sent by the master eNodeB, where the DRB establishing or adding request carries the key parameter; and the determining unit is specifically configured to obtain the key parameter from the DRB establishing or adding request, where the key parameter includes a DRB ID.

With reference to the third aspect or the first possible implementation manner of the third aspect or the second possible implementation manner of the third aspect, in a third possible implementation manner, the sending unit is specifically configured to send the key parameter to the UE by using the master eNodeB.

With reference to the third aspect or the first possible implementation manner of the third aspect or the second possible implementation manner of the third aspect or the third possible implementation manner of the third aspect, in a fourth possible implementation manner, the user plane key is a user plane cipher key or a user plane integrity protection key.

According to a fourth aspect, an embodiment of the present disclosure provides a master eNodeB, where the master eNodeB includes: a determining unit configured to determine a key parameter corresponding to a DRB; and a sending unit configured to send the key parameter to UE corresponding to the DRB, so that the UE generates a user plane key according to the key parameter and a basic key generated by the UE; where the sending unit is further configured to send the key parameter and a basic key generated by the master eNodeB to a secondary eNodeB, so that the secondary eNodeB generates the user plane key according to the key parameter and the basic key generated by the master eNodeB; or the master eNodeB further includes: a generating unit configured to generate the user plane key according to the key parameter and a basic key generated by the master eNodeB, where the sending unit is further configured to send the user plane key to a secondary eNodeB.

In a first possible implementation manner of the fourth aspect, the key parameter includes a DRB ID.

With reference to the fourth aspect or the first possible implementation manner of the fourth aspect, in a second possible implementation manner, the user plane key is a user plane cipher key or a user plane integrity protection key.

According to a fifth aspect, an embodiment of the present disclosure provides UE, where the UE includes: a receiving unit configured to receive a key parameter corresponding to a DRB sent by a master eNodeB or a secondary eNodeB; and a generating unit configured to generate a user plane key according to the key parameter and a basic key.

In a first possible implementation manner of the fifth aspect, the key parameter includes at least one of the following parameters: a DRB ID, a random number, or a counter value.

With reference to the fifth aspect or the first possible implementation manner of the fifth aspect, in a second possible implementation manner, the user plane key is a user plane cipher key or a user plane integrity protection key.

According to the foregoing solutions, a user plane key between UE and a secondary eNodeB is separately generated by the UE and the secondary eNodeB, so that load of a master eNodeB may be effectively reduced. In addition, different user plane keys between same UE and the secondary eNodeB are generated for different DRBs, so that security of the user plane keys between the secondary eNodeB and the UE may be effectively improved.

### BRIEF DESCRIPTION OF DRAWINGS

FIG. 1 is a schematic flowchart of a key generation method according to Embodiment 1 of the present disclosure;

FIG. 2 is a signaling diagram of the key generation method according to Embodiment 1 of the present disclosure;

FIG. 3 is a schematic flowchart of a key generation method according to Embodiment 2 of the present disclosure;

FIG. 4 is a signaling diagram of the key generation method according to Embodiment 2 of the present disclosure;

FIG. 5 is a schematic flowchart of a key generation method according to Embodiment 3 of the present disclosure;

FIG. 6 is a signaling diagram of the key generation method according to Embodiment 3 of the present disclosure;

FIG. 7 is a schematic structural diagram of a secondary eNodeB according to Embodiment 4 of the present disclosure;

FIG. 8 is a schematic structural diagram of a secondary eNodeB according to Embodiment 5 of the present disclosure;

FIG. 9 is a schematic structural diagram of a master eNodeB according to Embodiment 6 of the present disclosure;

FIG. 10 is a schematic structural diagram of a master eNodeB according to Embodiment 7 of the present disclosure;

FIG. 11 is a schematic structural diagram of a master eNodeB according to Embodiment 8 of the present disclosure;

FIG. 12 is a schematic structural diagram of a master eNodeB according to Embodiment 9 of the present disclosure;

FIG. 13 is a schematic structural diagram of UE according to Embodiment 10 of the present disclosure; and

FIG. 14 is a schematic structural diagram of UE according to Embodiment 11 of the present disclosure.

The following further describes in detail the technical solutions of the embodiments of the present disclosure with reference to the accompanying drawings and embodiments.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

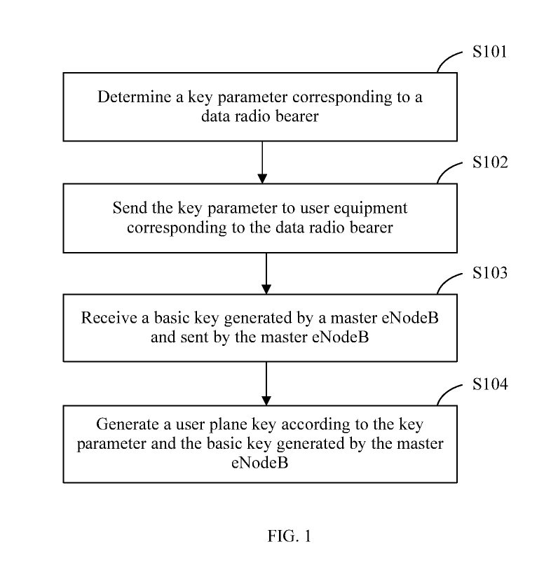

The following uses FIG. 1 as an example to describe in detail a key generation method provided in Embodiment 1 of the present disclosure. FIG. 1 is a schematic flowchart of a key generation method according to Embodiment 1 of the present disclosure. An execution body of the key generation method is a secondary eNodeB. The secondary eNodeB is a small cell, and the small cell is specifically a micro base station or a femto base station.

As shown in FIG. 1, the key generation method includes the following steps:

Step S101: Determine a key parameter corresponding to a (DRB).

The key parameter may be allocated by the secondary eNodeB or a master eNodeB. The master eNodeB is a macro base station.

Optionally, if the key parameter is allocated by the secondary eNodeB, the key parameter includes at least one of the following parameters: a DRB ID, a random number, or a counter value.

Specifically, after UE establishes a Radio Resource Control (RRC) protocol connection to the master eNodeB, the secondary eNodeB receives a DRB establishing or adding request sent by the master eNodeB. After receiving the DRB establishing or adding request, the secondary eNodeB allocates a DRB to the UE and allocates a DRB ID to the DRB. A DRB ID of each DRB is unique, and therefore the DRB ID may be used as a key parameter corresponding to the DRB.

The secondary eNodeB may include a random number generator. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the random number generator generates a random number for the DRB. Each random number generated by the random number generator is unique, and therefore the random number may be used as a key parameter corresponding to the DRB.

The secondary eNodeB may further include a counter. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the counter generates a counter value for the DRB. Each counter value generated by the counter is unique, and therefore the counter value may be used as a key parameter corresponding to the DRB.

Optionally, if the key parameter is allocated by the master eNodeB, before step S101, the following step is further included: receiving a DRB establishing or adding request sent by the master eNodeB, where the DRB establishing or adding request carries the key parameter.

The key parameter includes only a DRB ID.

Specifically, after UE establishes an RRC connection to the master eNodeB, the master eNodeB allocates a DRB to the UE. A DRB ID of each DRB is unique, and therefore the DRB ID may be used as a key parameter corresponding to the DRB.

Accordingly, step S101 is specifically: obtaining the key parameter from the received DRB establishing or adding request.

Step S102: Send the key parameter to UE corresponding to the DRB.

Optionally, the secondary eNodeB may first send the key parameter to the master eNodeB, and then the master eNodeB forwards the key parameter to the UE.

After receiving the key parameter sent by the master eNodeB, the UE performs, by using a key derivation function (KDF), calculation on the key parameter and a basic key (for example, a secondary eNodeB key (S-KeNB)) generated by the UE, so as to generate a user plane key.

Step S103: Receive a basic key generated by a master eNodeB and sent by the master eNodeB.

The basic key generated by the UE and the basic key generated by the master eNodeB are the same.

Specifically, the UE and the master eNodeB separately perform calculation on a same shared key (for example, a base station key (KeNB)) and a same shared key parameter by using the key derivation function KDF, so as to generate a basic key. Therefore, the basic key generated by the UE and the basic key generated by the master eNodeB are the same.

Step S104: Generate a user plane key according to the key parameter and the basic key generated by the master eNodeB.

The secondary eNodeB generates, in a same manner in which the UE generates a user plane key, the user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the secondary eNodeB are the same.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

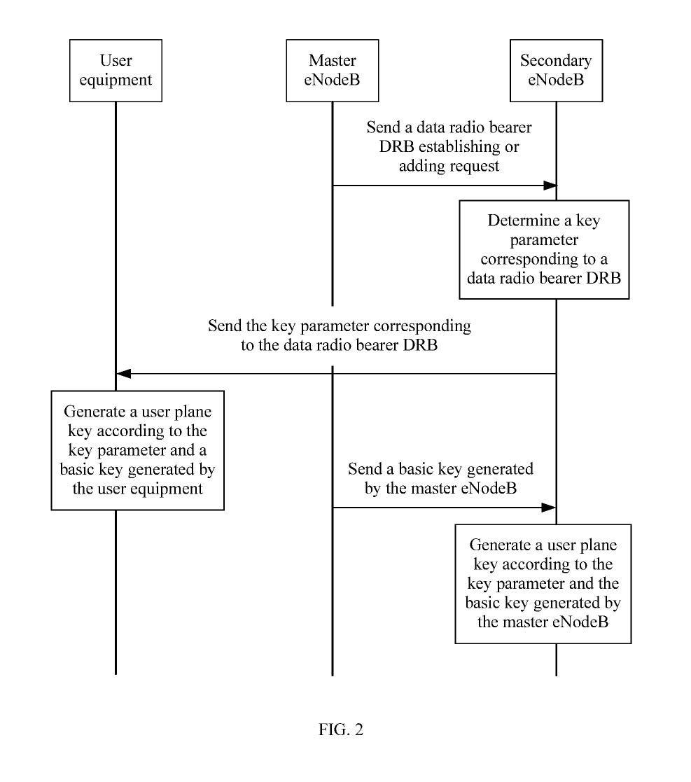

Further, FIG. 2 is a signaling diagram of the key generation method according to Embodiment 1 of the present disclosure. The signaling diagram shown in FIG. 2 shows in detail a procedure of interaction among UE, a master eNodeB, and a secondary eNodeB. The secondary eNodeB in FIG. 2 is the execution body of the key generation method provided in Embodiment 1. Key generation methods in FIG. 2 may all be executed according to a process described in the foregoing Embodiment 1, and are not repeated herein.

According to the used key generation method provided in Embodiment 1 of the present disclosure, a user plane key between UE and a secondary eNodeB is separately generated by the UE and the secondary eNodeB, so that load of a master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

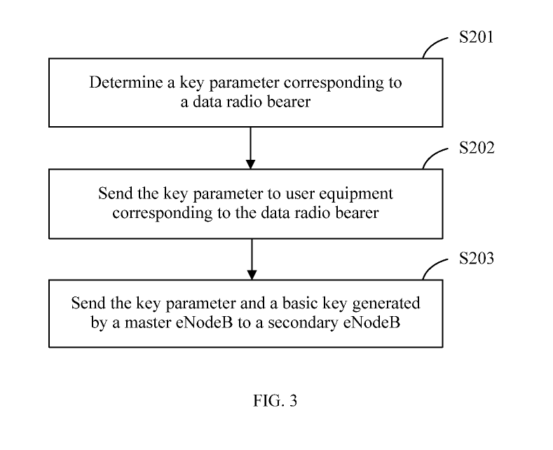

The following uses FIG. 3 as an example to describe in detail a key generation method provided in Embodiment 2 of the present disclosure. FIG. 3 is a schematic flowchart of a key generation method according to Embodiment 2 of the present disclosure. An execution body of the key generation method is a master eNodeB. The master eNodeB is a macro base station.

As shown in FIG. 3, the key generation method includes the following steps:

Step S201: Determine a key parameter corresponding to a DRB.

The key parameter includes a DRB ID.

Specifically, after UE establishes an RRC connection to the master eNodeB, the master eNodeB allocates a DRB to the UE and allocates a DRB ID to the DRB. A DRB ID of each DRB is unique, and therefore the DRB ID may be used as a key parameter corresponding to the DRB.

Step S202: Send the key parameter to UE corresponding to the DRB.

After receiving the key parameter sent by a master eNodeB, the UE performs, by using a key derivation function KDF, calculation on the key parameter and a basic key (for example, an S-KeNB) generated by the UE, so as to generate a user plane key.

The secondary eNodeB is a small cell, and the small cell is specifically a micro base station or a femto base station.

Step S203: Send the key parameter and a basic key generated by the master eNodeB to a secondary eNodeB.

The basic key generated by the UE and the basic key generated by the master eNodeB are the same.

Specifically, the UE and the master eNodeB separately perform calculation on a same shared key (for example, a KeNB) and a same shared key parameter by using the key derivation function KDF, so as to generate a basic key. Therefore, the basic key generated by the UE and the basic key generated by the master eNodeB are the same.

The secondary eNodeB generates, in a same manner in which the UE generates a user plane key, a user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the secondary eNodeB are the same.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

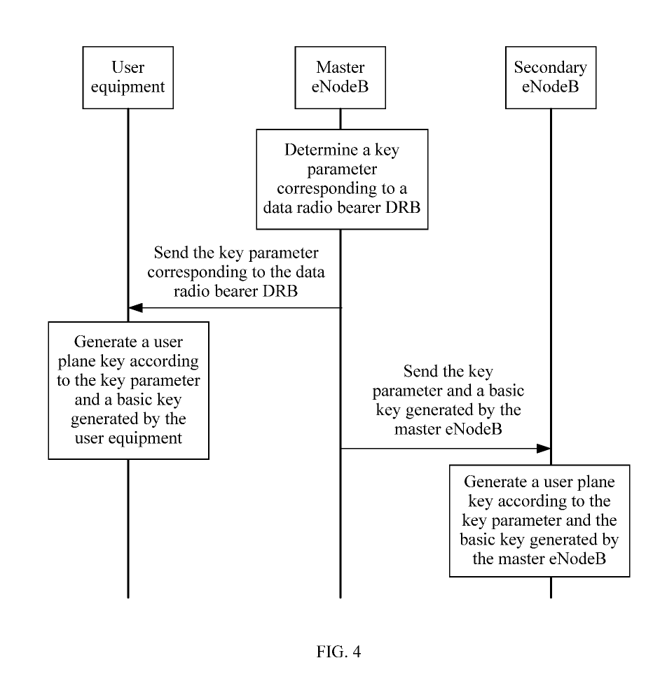

Further, FIG. 4 is a signaling diagram of the key generation method according to Embodiment 2 of the present disclosure. The signaling diagram shown in FIG. 4 shows in detail a procedure of interaction among UE, a master eNodeB, and a secondary eNodeB. The master eNodeB in FIG. 4 is the execution body of the key generation method provided in Embodiment 2. Key generation methods in FIG. 4 may all be executed according to a process described in the foregoing Embodiment 2, and are not repeated herein.

According to the used key generation method provided in Embodiment 2 of the present disclosure, a user plane key between UE and a secondary eNodeB is separately generated by the UE and the secondary eNodeB, so that load of a master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

The following uses FIG. 5 as an example to describe in detail a key generation method provided in Embodiment 3 of the present disclosure. FIG. 5 is a schematic flowchart of a key generation method according to Embodiment 3 of the present disclosure. An execution body of the key generation method is a master eNodeB. The master eNodeB is a macro base station.

As shown in FIG. 5, the key generation method includes the following steps:

Step S301: Determine a key parameter corresponding to a DRB.

The key parameter includes a DRB ID.

Specifically, after UE establishes an RRC connection to the master eNodeB, the master eNodeB allocates a DRB to the UE and allocates a DRB ID to the DRB. A DRB ID of each DRB is unique, and therefore the DRB ID may be used as a key parameter corresponding to the DRB.

Step S302: Send the key parameter to UE corresponding to the DRB.

After receiving the key parameter sent by a master eNodeB, the UE performs, by using a key derivation function KDF, calculation on the key parameter and a basic key (for example, an S-KeNB) generated by the UE, so as to generate a user plane key.

The secondary eNodeB is a small cell, and the small cell is specifically a micro base station or a femto base station.

Step S303: Generate a user plane key according to the key parameter and a basic key generated by the master eNodeB.

The basic key generated by the UE and the basic key generated by the master eNodeB are the same.

Specifically, the UE and the master eNodeB separately perform calculation on a same shared key (for example, a base station key KeNB) and a same shared key parameter by using the key derivation function KDF, so as to generate a basic key. Therefore, the basic key generated by the UE and the basic key generated by the master eNodeB are the same. The master eNodeB generates, in a same manner in which the UE generates a user plane key, the user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the master eNodeB are the same.

Step S304: Send the generated user plane key to a secondary eNodeB.

The secondary eNodeB uses the user plane key sent by the master eNodeB as a user plane key between the UE and the secondary eNodeB.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

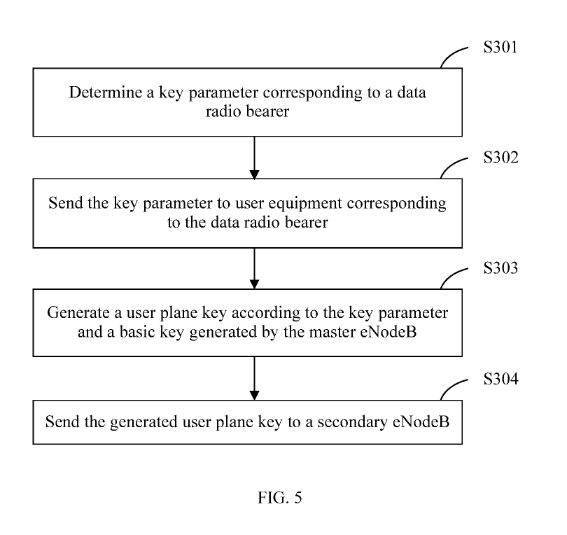

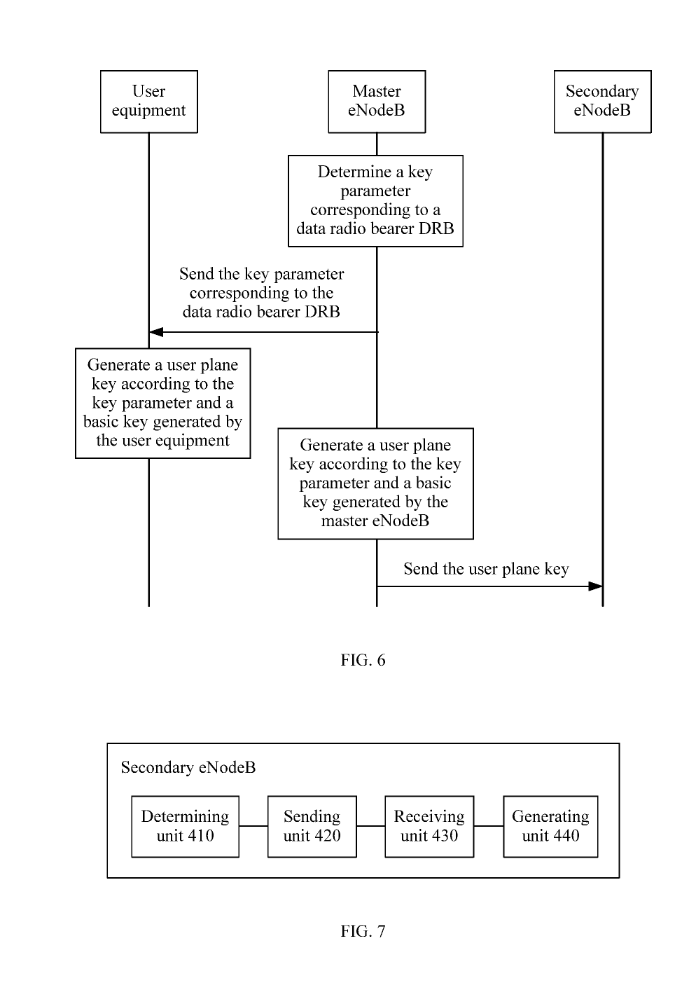

Further, FIG. 6 is a signaling diagram of the key generation method according to Embodiment 3 of the present disclosure. The signaling diagram shown in FIG. 6 shows in detail a procedure of interaction among UE, a master eNodeB, and a secondary eNodeB. The master eNodeB in FIG. 6 is the execution body of the key generation method provided in Embodiment 3. Key generation methods in FIG. 6 may all be executed according to a process described in the foregoing Embodiment 3, and are not repeated herein.

According to the used key generation method provided in Embodiment 3 of the present disclosure, a user plane key between UE and a secondary eNodeB is separately generated by the UE and a master eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

The following uses FIG. 7 as an example to describe in detail a secondary eNodeB provided in Embodiment 4 of the present disclosure. FIG. 7 is a schematic structural diagram of a secondary eNodeB according to Embodiment 4 of the present disclosure. The secondary eNodeB is a small cell, and the small cell is specifically a micro base station or a femto base station configured to implement the key generation method provided in Embodiment 1 of the present disclosure.

As shown in FIG. 7, the secondary eNodeB includes: a determining unit 410, a sending unit 420, a receiving unit 430, and a generating unit 440.

The determining unit 410 is configured to determine a key parameter corresponding to a DRB.

The key parameter may be allocated by the secondary eNodeB or a master eNodeB. The master eNodeB is a macro base station.

Optionally, if the key parameter is allocated by the secondary eNodeB, the key parameter includes at least one of the following parameters: a DRB ID, a random number, or a counter value.

Specifically, after UE establishes an RRC connection to the master eNodeB, the secondary eNodeB receives a DRB establishing or adding request sent by the master eNodeB. After receiving the DRB establishing or adding request, the secondary eNodeB allocates a DRB to the UE, and the determining unit 410 allocates a DRB ID to the DRB. A DRB ID of each DRB is unique, and therefore the determining unit 410 uses the DRB ID as a key parameter corresponding to the DRB.

The determining unit 410 may include a random number generator. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the random number generator generates a random number for the DRB. Each random number generated by the random number generator is unique, and therefore the determining unit 410 may use the random number as a key parameter corresponding to the DRB.

The determining unit 410 may further include a counter. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the counter generates a counter value for the DRB. Each counter value generated by the counter is unique, and therefore the determining unit 410 may use the counter value as a key parameter corresponding to the DRB.

Optionally, if the key parameter is allocated by the master eNodeB, the receiving unit 430 is configured to receive a DRB establishing or adding request sent by the master eNodeB, where the DRB establishing or adding request carries the key parameter.

The key parameter includes only a DRB ID.

Specifically, after UE establishes an RRC connection to the master eNodeB, the master eNodeB allocates a DRB to the UE and allocates a DRB ID to the DRB. A DRB ID of each DRB is unique, and therefore the DRB ID may be used as a key parameter corresponding to the DRB.

Accordingly, the determining unit 410 is specifically configured to obtain the key parameter from the received DRB establishing or adding request.

The sending unit 420 is configured to send the key parameter to UE corresponding to the DRB.

Optionally, the sending unit 420 may first send the key parameter to the master eNodeB, and then the master eNodeB forwards the key parameter to the UE.

After receiving the key parameter sent by the master eNodeB, the UE performs, by using a key derivation function KDF, calculation on the key parameter and a basic key (for example, an S-KeNB) generated by the UE, so as to generate a user plane key.

The receiving unit 430 is configured to receive a basic key generated by the master eNodeB and sent by the master eNodeB.

The basic key generated by the UE and the basic key generated by the master eNodeB are the same.

Specifically, the UE and the master eNodeB separately perform calculation on a same shared key (for example, a KeNB) and a same shared key parameter by using the key derivation function KDF, so as to generate a basic key. Therefore, the basic key generated by the UE and the basic key generated by the master eNodeB are the same.

The generating unit 440 is configured to generate a user plane key according to the key parameter and the basic key generated by the master eNodeB.

The generating unit 440 generates, in a same manner in which the UE generates a user plane key, the user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the generating unit 440 are the same.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

According to the used secondary eNodeB provided in Embodiment 4 of the present disclosure, a user plane key between UE and the secondary eNodeB is separately generated by the UE and the secondary eNodeB, so that load of a master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

In hardware implementation, the foregoing sending unit 420 may be a transmitter or a transceiver, the foregoing receiving unit 430 may be a receiver or a transceiver, and the sending unit 420 and the receiving unit 430 may be integrated to constitute a transceiver unit, which is a transceiver corresponding to the hardware implementation. The foregoing determining unit 410 and the generating unit 440 may be built in or independent of a processor of the secondary eNodeB in a hardware form, or may be stored in a memory of the secondary eNodeB in a software form, so that the processor invokes and executes an operation corresponding to each of the foregoing modules. The processor may be a central processing unit (CPU), a microprocessor, a single-chip microcomputer, or the like.

As shown in FIG. 8, FIG. 8 is a schematic structural diagram of a secondary eNodeB according to Embodiment 5 of the present disclosure. The secondary eNodeB includes a transmitter 510, a receiver 520, a memory 530, and a processor 540 separately connected to the transmitter 510, the receiver 520, and the memory 530. Certainly, the secondary eNodeB may further include general components, such as an antenna, a baseband processing component, an intermediate radio frequency processing component, and an input and output apparatus. This embodiment of the present disclosure sets no limitation thereto. The secondary eNodeB is a small cell, and the small cell is specifically a micro base station or a femto base station configured to implement the key generation method provided in Embodiment 1 of the present disclosure.

The memory 530 stores a set of program code, and the processor 540 is configured to invoke the program code stored in the memory 530, so as to execute the following operations: determining a key parameter corresponding to a DRB; sending the key parameter to UE corresponding to the DRB, so that the UE generates a user plane key according to the key parameter and a basic key generated by the UE; receiving a basic key generated by a master eNodeB and sent by the master eNodeB; and generating the user plane key according to the key parameter and the basic key generated by the master eNodeB; where the basic key generated by the UE and the basic key generated by the master eNodeB are the same.

Further, the determining a key parameter corresponding to a DRB is specifically: allocating or generating a key parameter for the DRB, where the key parameter includes at least one of the following parameters: a DRB ID, a random number, or a counter value.

Further, the processor 540 is configured to invoke the program code stored in the memory 530, so as to further execute the following operations: before the determining a key parameter corresponding to a DRB, receiving a DRB establishing or adding request sent by the master eNodeB, where the DRB establishing or adding request carries the key parameter; and the determining a key parameter corresponding to a DRB is specifically: obtaining the key parameter from the DRB establishing or adding request, where the key parameter includes a DRB ID.

Further, the sending the key parameter to UE corresponding to the DRB is specifically: sending the key parameter to the UE by using the master eNodeB.

Further, the user plane key is a user plane cipher key or a user plane integrity protection key.

The master eNodeB is a macro base station.

According to the used secondary eNodeB provided in Embodiment 5 of the present disclosure, a user plane key between UE and the secondary eNodeB is separately generated by the UE and the secondary eNodeB, so that load of a master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

The following uses FIG. 9 as an example to describe in detail a master eNodeB provided in Embodiment 6 of the present disclosure. FIG. 9 is a schematic structural diagram of a master eNodeB according to Embodiment 6 of the present disclosure. The master eNodeB is a macro base station configured to implement the key generation method provided in Embodiment 2 of the present disclosure.

As shown in FIG. 9, the master eNodeB includes: a determining unit 610 and a sending unit 620.

The determining unit 610 is configured to determine a key parameter corresponding to a DRB.

The key parameter includes a DRB ID.

Specifically, after UE establishes an RRC connection to the master eNodeB, the master eNodeB allocates a DRB to the UE, and the determining unit 610 allocates a DRB ID to the DRB. A DRB ID of each DRB is unique, and therefore the determining unit 610 uses the DRB ID as a key parameter corresponding to the DRB.

The sending unit 620 is configured to send the key parameter to UE corresponding to the DRB.

After receiving the key parameter sent by a master eNodeB, the UE performs, by using a key derivation function KDF, calculation on the key parameter and a basic key (for example an S-KeNB) generated by the UE, so as to generate a user plane key.

The secondary eNodeB is a small cell, and the small cell is specifically a micro base station or a femto base station.

The sending unit 620 is further configured to send the key parameter and a basic key generated by the master eNodeB to the secondary eNodeB.

The basic key generated by the UE and the basic key generated by the master eNodeB are the same.

Specifically, the UE and the master eNodeB separately perform calculation on a same shared key (for example, a KeNB) and a same shared key parameter by using the key derivation function KDF, so as to generate a basic key. Therefore, the basic key generated by the UE and the basic key generated by the master eNodeB are the same.

The secondary eNodeB generates, in a same manner in which the UE generates a user plane key, a user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the secondary eNodeB are the same.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

According to the used master eNodeB provided in Embodiment 6 of the present disclosure, a user plane key between UE and a secondary eNodeB is separately generated by the UE and the secondary eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

In hardware implementation, the foregoing sending unit 620 may be a transmitter or a transceiver, and the foregoing determining unit 610 may be built in or independent of a processor of the master eNodeB in a hardware form, or may be stored in a memory of the master eNodeB in a software form, so that the processor invokes and executes an operation corresponding to each of the foregoing modules. The processor may be a CPU, a microprocessor, a single-chip microcomputer, or the like.

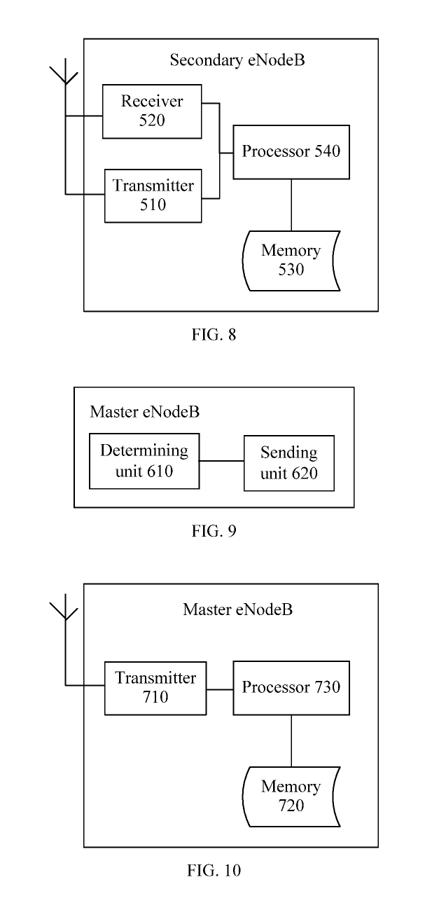

As shown in FIG. 10, FIG. 10 is a schematic structural diagram of a master eNodeB according to Embodiment 7 of the present disclosure. The master eNodeB includes a transmitter 710, a memory 720, and a processor 730 separately connected to the transmitter 710 and the memory 720. Certainly, the master eNodeB may further include general components, such as an antenna, a baseband processing component, an intermediate radio frequency processing component, and an input and output apparatus. This embodiment of the present disclosure sets no limitation thereto. The master eNodeB is a macro base station configured to implement the key generation method provided in Embodiment 2 of the present disclosure.

The memory 720 stores a set of program code, and the processor 730 is configured to invoke the program code stored in the memory 720, so as to execute the following operations: determining a key parameter corresponding to a DRB; sending the key parameter to UE corresponding to the DRB, so that the UE generates a user plane key according to the key parameter and a basic key generated by the UE; and sending the key parameter and a basic key generated by the master eNodeB to a secondary eNodeB, so that the secondary eNodeB generates the user plane key according to the key parameter and the basic key generated by the master eNodeB; where the basic key generated by the UE and the basic key generated by the master eNodeB are the same.

Further, the key parameter includes a DRB ID.

Further, the user plane key is a user plane cipher key or a user plane integrity protection key.

The secondary eNodeB is a small cell, and the small cell is specifically a micro base station or a femto base station.

According to the used master eNodeB provided in Embodiment 7 of the present disclosure, a user plane key between UE and a secondary eNodeB is separately generated by the UE and the secondary eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

The following uses FIG. 11 as an example to describe in detail a master eNodeB provided in Embodiment 8 of the present disclosure. FIG. 11 is a schematic structural diagram of a master eNodeB according to Embodiment 8 of the present disclosure. The master eNodeB is a macro base station configured to implement the key generation method provided in Embodiment 3 of the present disclosure.

As shown in FIG. 11, the master eNodeB includes: a determining unit 810, a sending unit 820, and a generating unit 830.

The determining unit 810 is configured to determine a key parameter corresponding to a DRB.

The key parameter includes a DRB ID.

Specifically, after UE establishes an RRC connection to the master eNodeB, the master eNodeB allocates a DRB to the UE, and the determining unit 810 allocates a DRB ID to the DRB. A DRB ID of each DRB is unique, and therefore the determining unit 810 uses the DRB ID as a key parameter corresponding to the DRB.

The sending unit 820 is configured to send the key parameter to UE corresponding to the DRB.

After receiving the key parameter sent by a master eNodeB, the UE performs, by using a key derivation function KDF, calculation on the key parameter and a basic key (for example, an S-KeNB) generated by the UE, so as to generate a user plane key.

The secondary eNodeB is a small cell, and the small cell is specifically a micro base station or a femto base station.

The generating unit 830 is configured to generate a user plane key according to the key parameter and a basic key generated by the master eNodeB.

The basic key generated by the UE and the basic key generated by the master eNodeB are the same.

Specifically, the UE and the master eNodeB separately perform calculation on a same shared key (for example, a KeNB) and a same shared key parameter by using the key derivation function KDF, so as to generate a basic key. Therefore, the basic key generated by the UE and the basic key generated by the master eNodeB are the same.

The generating unit 830 generates, in a same manner in which the UE generates a user plane key, the user plane key according to the key parameter and the basic key generated by the master eNodeB. Because the basic key generated by the UE and the basic key generated by the master eNodeB are the same, and a same user plane key generation manner is used, the user plane key generated by the UE and the user plane key generated by the generating unit 830 are the same.

The sending unit 820 is further configured to send the generated user plane key to the secondary eNodeB.

The secondary eNodeB uses the user plane key sent by the master eNodeB as a user plane key between the UE and the secondary eNodeB.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

According to the used master eNodeB provided in Embodiment 8 of the present disclosure, a user plane key between UE and a secondary eNodeB is separately generated by the UE and the master eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

In hardware implementation, the foregoing sending unit 820 may be a transmitter or a transceiver, and the foregoing determining unit 810 and the generating unit 830 may be built in or independent of a processor of the master eNodeB in a hardware form, or may be stored in a memory of the master eNodeB in a software form, so that the processor invokes and executes an operation corresponding to each of the foregoing modules. The processor may be a CPU, a microprocessor, a single-chip microcomputer, or the like.

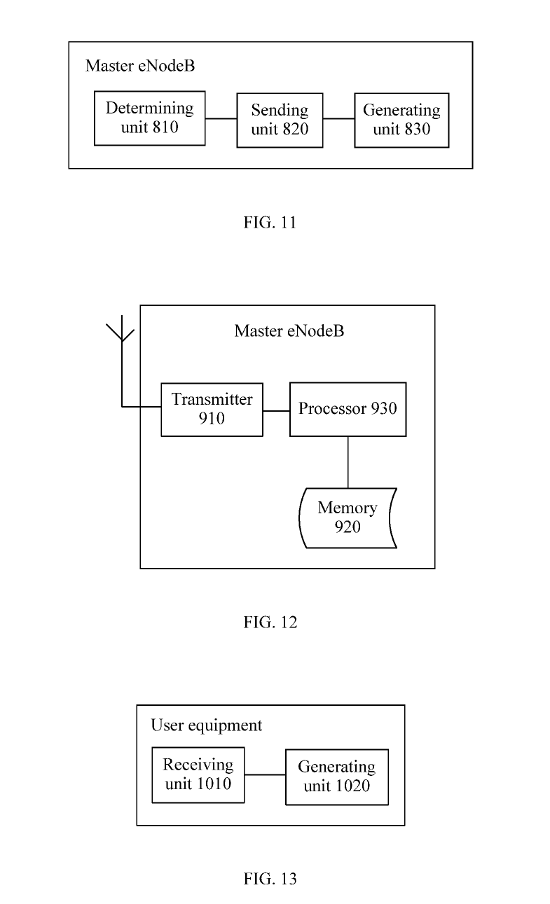

As shown in FIG. 12, FIG. 12 is a schematic structural diagram of a master eNodeB according to Embodiment 9 of the present disclosure. The master eNodeB includes a transmitter 910, a memory 920, and a processor 930 separately connected to the transmitter 910 and the memory 920. Certainly, the master eNodeB may further include general components, such as an antenna, a baseband processing component, an intermediate radio frequency processing component, and an input and output apparatus. This embodiment of the present disclosure sets no limitation thereto. The master eNodeB is a macro base station configured to implement the key generation method provided in Embodiment 2 of the present disclosure.

The memory 920 stores a set of program code, and the processor 930 is configured to invoke the program code stored in the memory 920, so as to execute the following operations: determining a key parameter corresponding to a DRB; sending the key parameter to UE corresponding to the DRB, so that the UE generates a user plane key according to the key parameter and a basic key generated by the UE; generating the user plane key according to the key parameter and a basic key generated by the master eNodeB; and sending the user plane key to a secondary eNodeB; where the basic key generated by the UE and the basic key generated by the master eNodeB are the same.

Further, the key parameter includes a DRB ID.

Further, the user plane key is a user plane cipher key or a user plane integrity protection key.

The secondary eNodeB is a small cell, and the small cell is specifically a micro base station or a femto base station.

According to the used master eNodeB provided in Embodiment 9 of the present disclosure, a user plane key between UE and a secondary eNodeB is separately generated by the UE and the master eNodeB, so that load of the master eNodeB may be effectively reduced. In addition, because key parameters of different UE are different, user plane keys between the secondary eNodeB and the different UE are different; because different DRBs of same UE correspond to different key parameters, different user plane keys between the same UE and the secondary eNodeB are generated for the different DRBs, so that security of the user plane keys between the secondary eNodeB and the UE may be effectively improved.

The following uses FIG. 13 as an example to describe in detail UE provided in Embodiment 10 of the present disclosure. FIG. 13 is a schematic structural diagram of UE according to Embodiment 10 of the present disclosure. The UE may be UE described in Embodiment 1, Embodiment 2, or Embodiment 3.

As shown in FIG. 13, the UE includes: a receiving unit 1010 and a generating unit 1020.

The receiving unit 1010 is configured to receive a key parameter corresponding to a DRB sent by a master eNodeB or a secondary eNodeB.

The master eNodeB is a macro base station. The secondary eNodeB is a small cell, and the small cell is specifically a micro base station or a femto base station.

Specifically, the key parameter may be allocated by the secondary eNodeB or the master eNodeB.

Optionally, if the key parameter is allocated by the secondary eNodeB, the key parameter includes at least one of the following parameters: a DRB ID, a random number, or a counter value.

Specifically, after the UE establishes an RRC connection to the master eNodeB, the secondary eNodeB receives a DRB establishing or adding request sent by the master eNodeB. After receiving the DRB establishing or adding request, the secondary eNodeB allocates a DRB to the UE and allocates a DRB ID to the DRB. A DRB ID of each DRB is unique, and therefore the DRB ID may be used as a key parameter corresponding to the DRB.

The secondary eNodeB may include a random number generator. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the random number generator generates a random number for the DRB. Each random number generated by the random number generator is unique, and therefore the random number may be used as a key parameter corresponding to the DRB.

The secondary eNodeB may further include a counter. After the UE establishes the RRC connection to the master eNodeB, the secondary eNodeB receives a DRB establishing or adding request sent by the master eNodeB. After receiving the DRB establishing or adding request, the secondary eNodeB allocates a DRB to the UE, and then the counter generates a counter value for the DRB. Each counter value generated by the counter is unique, and therefore the counter value may be used as a key parameter corresponding to the DRB.

After allocating the key parameter, the secondary eNodeB may directly send the key parameter to the UE; or first send the key parameter to the master eNodeB, and the master eNodeB forwards the key parameter to the UE.

Optionally, if the key parameter is allocated by the master eNodeB, the key parameter includes only a DRB ID.

Specifically, after the UE establishes an RRC connection to the master eNodeB, the master eNodeB allocates a DRB to the UE. A DRB ID of each DRB is unique, and therefore the DRB ID may be used as a key parameter corresponding to the DRB.

After allocating the key parameter, the master eNodeB may directly send the key parameter to the UE; or first send the key parameter to the secondary eNodeB, and the secondary eNodeB forwards the key parameter to the UE.

The generating unit 1020 is configured to generate a user plane key according to the key parameter and a basic key.

After the receiving unit 1010 receives the key parameter, the generating unit 1020 performs, by using a key derivation function KDF, calculation on the key parameter and a basic key (for example, a secondary eNodeB key S-KeNB) generated by the UE, so as to generate a user plane key.

Correspondingly, a user plane key of the secondary eNodeB is generated by the secondary eNodeB or the master eNodeB. The secondary eNodeB or the master eNodeB generates the user plane key according to the key parameter and a basic key generated by the master eNodeB.

The basic key generated by the UE and the basic key generated by the master eNodeB are the same.

Specifically, the UE and the master eNodeB separately perform calculation on a same shared key (for example, a KeNB) and a same shared key parameter by using the key derivation function KDF, so as to generate a basic key. Therefore, the basic key generated by the UE and the basic key generated by the master eNodeB are the same.

In addition, the secondary eNodeB or the master eNodeB generates, in a same manner in which the UE generates a user plane key, the user plane key according to the key parameter and the basic key generated by the master eNodeB. Because the basic key generated by the UE and the basic key generated by the secondary eNodeB or the master eNodeB are the same, and a same user plane key generation manner is used, the user plane key generated by the UE and the user plane key generated by the secondary eNodeB or the master eNodeB are the same.

Optionally, the user plane key generated in this embodiment may be specifically a user plane cipher key. Before sending user plane data, the UE or the secondary eNodeB encrypts, according to the generated user plane cipher key, the user plane data to form a ciphertext, so that the data cannot be cracked in a sending process. Correspondingly, after receiving the user plane data, the UE or the secondary eNodeB decrypts the user plane data according to the generated user plane cipher key to obtain original user plane data.

Optionally, the user plane key generated in this embodiment may be specifically a user plane integrity protection key. Before sending user plane data, the UE or the secondary eNodeB performs integrity protection on the user plane data according to the generated user plane integrity protection key, so that the data cannot be tampered in a sending process. Correspondingly, after receiving the user plane data, the UE or the secondary eNodeB checks integrity of the user plane data according to the generated user plane integrity protection key, so as to ensure that the user plane data is not tampered.

According to the used UE provided in Embodiment 10 of the present disclosure, a user plane key between the UE and a secondary eNodeB is separately generated by the UE and the secondary eNodeB, or separately generated by the UE and a master eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

In hardware implementation, the foregoing receiving unit 1010 may be a receiver or a transceiver, and the foregoing generating unit 1020 may be built in or independent of a processor of the UE in a hardware form, or may be stored in a memory of the UE in a software form, so that the processor invokes and executes an operation corresponding to each of the foregoing modules. The processor may be a CPU, a microprocessor, a single-chip microcomputer, or the like.

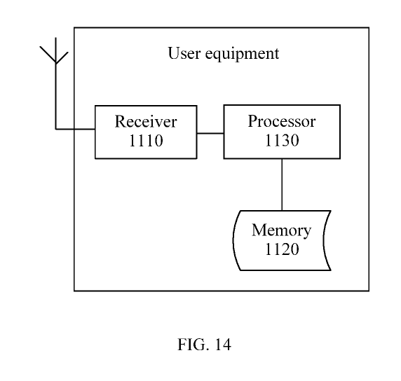

As shown in FIG. 14, FIG. 14 is a schematic structural diagram of UE according to Embodiment 11 of the present disclosure. The UE includes a receiver 1110, a memory 1120, and a processor 1130 separately connected to the receiver 1110 and the memory 1120. Certainly, the UE may further include general components, such as an antenna, a baseband processing component, an intermediate radio frequency processing component, and an input and output apparatus. This embodiment of the present disclosure sets no limitation thereto. The UE may be UE described in Embodiment 1, Embodiment 2, or Embodiment 3.

The memory 1120 stores a set of program code, and the processor 1130 is configured to invoke the program code stored in the memory 1120, so as to execute the following operations: receiving a key parameter corresponding to a DRB sent by a master eNodeB or a secondary eNodeB; and generating a user plane key according to the key parameter and a basic key.

Further, the key parameter includes at least one of the following parameters: a DRB ID, a random number, or a counter value.

Further, the user plane key is a user plane cipher key or a user plane integrity protection key.

The master eNodeB is a macro base station. The secondary eNodeB is a small cell, and the small cell is specifically a micro base station or a femto base station.

According to the used UE provided in Embodiment 11 of the present disclosure, a user plane key between the UE and a secondary eNodeB is separately generated by the UE and the secondary eNodeB, or separately generated by the UE and a master eNodeB, so that load of the master eNodeB may be effectively reduced. In addition, because different DRBs of same UE correspond to different key parameters, different user plane keys between the same UE and the secondary eNodeB are generated for the different DRBs, so that security of the user plane keys between the secondary eNodeB and the UE may be effectively improved.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

Steps of methods or algorithms described in the embodiments disclosed in this specification may be implemented by hardware, a software module executed by a processor, or a combination thereof. The software module may reside in a random-access memory (RAM), a memory, a read-only memory (ROM), an electrically programmable ROM, an electrically erasable programmable ROM, a register, a hard disk, a removable disk, a compact disc ROM (CD-ROM), or any other form of storage medium known in the art.

In the foregoing specific implementation manners, the objective, technical solutions, and benefits of the present disclosure are further described in detail. It should be understood that the foregoing descriptions are merely specific implementation manners of the present disclosure, but are not intended to limit the protection scope of the present disclosure. Any modification, equivalent replacement, or improvement made without departing from the spirit and principle of the present disclosure should fall within the protection scope of the present disclosure.

What is claimed is:

1. A key generation method comprising:
determining a key parameter corresponding to a data radio bearer (DRB);
transmitting the key parameter to a user equipment (UE) corresponding to the DRB;
receiving from a master evolved node B (eNodeB) a basic key generated by the master eNodeB; and
generating the user plane key according to the key parameter and the basic key.

2. The method of claim 1, wherein determining the key parameter comprises allocating or generating the key parameter, and wherein the key parameter comprises at least one of a DRB identifier (ID), a random number, or a counter value.

3. The method of claim 1, wherein before determining the key parameter, the method further comprises receiving from the master eNodeB a DRB establishing or adding request comprising the key parameter, wherein determining the key parameter comprises obtaining the key parameter from the DRB establishing or adding request, and wherein the key parameter comprises a DRB identifier (ID).

4. The method of claim 1, wherein transmitting the key parameter comprises transmitting the key parameter to the UE using the master eNodeB.

5. The method of claim 1, wherein the user plane key is a user plane cipher key or a user plane integrity protection key.

6. A key generation method comprising:
determining a key parameter corresponding to a data radio bearer (DRB);
transmitting the key parameter to a user equipment (UE) corresponding to the DRB for the UE to generate a user plane key according to the key parameter and a basic key generated by a master evolved node B (eNodeB); and
transmitting the key parameter and the basic key to a secondary eNodeB for the secondary eNodeB to generate the user plane key according to the key parameter and the basic key; or
generating the user plane key according to the key parameter and the basic key and transmitting the user plane key to a secondary eNodeB.

7. The method of claim 6, wherein the key parameter comprises a DRB identifier (ID).

8. The method of claim 6, wherein the user plane key is a user plane cipher key or a user plane integrity protection key.

9. A secondary evolved node B (eNodeB) comprising:
a processor configured to determine a key parameter corresponding to a data radio bearer (DRB);
a transmitter coupled to the processor and configured to transmit the key parameter to a user equipment (UE) corresponding to the DRB; and
a receiver coupled to the processor and configured to receive from a master eNodeB a basic key generated by the master eNodeB,
wherein the processor is further configured to generate the user plane key according to the key parameter and the basic key.

10. The secondary eNodeB of claim 9, wherein the processor is further configured to determine the key parameter by allocating or generating the key parameter, and wherein the key parameter comprises at least one of a DRB identifier (ID), a random number, or a counter value.

11. The secondary eNodeB of claim 9, wherein the receiver is further configured to receive from the master eNodeB a DRB establishing or adding request comprising the key parameter.

12. The secondary eNodeB of claim 11, wherein the processor is further configured to obtain the key parameter from the DRB establishing or adding request, and wherein the key parameter comprises a DRB identifier (ID).

13. The secondary eNodeB of claim 9, wherein the transmitter is further configured to transmit the key parameter to the UE using the master eNodeB.

14. The secondary eNodeB of claim 9, wherein the user plane key is a user plane cipher key or a user plane integrity protection key.

15. A master evolved node B (eNodeB) comprising:
a processor configured to determine a key parameter corresponding to a data radio bearer (DRB);
generate a basic key; and
a transmitter coupled to the processor and configured to transmit the key parameter to a user equipment (UE) corresponding to the DRB for the UE to generate a user plane key according to the key parameter and a basic key,
wherein the transmitter is further configured to transmit the key parameter and the basic key to a secondary eNodeB for the secondary eNodeB to generate the user plane key according to the key parameter and the basic key; or
wherein the processor is further configured to generate the user plane key according to the key parameter and the basic key, and wherein the transmitter is further configured to transmit the user plane key to a secondary eNodeB.

16. The master eNodeB of claim 15, wherein the key parameter comprises a DRB identifier (ID).

17. The master eNodeB of claim 15, wherein the user plane key is a user plane cipher key or a user plane integrity protection key.

18. A user equipment (UE) comprising:
a receiver configured to receive a key parameter corresponding to a data radio bearer (DRB) from a master evolved node B (eNodeB) or a secondary eNodeB; and
a processor coupled to the receiver and configured to generate a user plane key according to the key parameter and a basic key.

19. The UE of claim 18, wherein the key parameter comprises at least one of a DRB identifier (ID), a random number, or a counter value.

20. The UE of claim 18, wherein the user plane key is a user plane cipher key or a user plane integrity protection key.
